(19) United States
(12) Patent Application Publication
(10) Pub. No.: US 2026/0120565 A1
(43) Pub. Date: Apr. 30, 2026

(54) INTELLIGENT VEHICLE RECOGNITION DEVICE AND METHOD APPLIED TO INTELLIGENT TRANSPORTATION SYSTEM

(71) Applicant: SMART RADAR SYSTEM, INC., Seongnam-si (KR)

(72) Inventors: Keun Hwan KIM, Yongin-si (KR); Yong Jae KIM, Yongin-si (KR)

(73) Assignee: SMART RADAR SYSTEM, INC., Seongnam-si (KR)

(21) Appl. No.: 19/315,566

(22) Filed: Aug. 31, 2025

(30) Foreign Application Priority Data
Oct. 31, 2024 (KR) 10-2024-0152197

(51) Int. Cl. G08G 1/017; G08G 1/015; G08G 1/04; G08G 1/052

(52) U.S. Cl. CPC G08G 1/017; G08G 1/015; G08G 1/04; G08G 1/052

(57) ABSTRACT

There is provided an intelligent vehicle recognition technology, particularly, a technology related to intelligent vehicle recognition applied to an intelligent transportation system, in which a plurality of tracks of a vehicle driving on a road are created based on a point cloud created by 4D radar signal processing, a distribution of the tracks is analyzed, and a type of moving vehicle is determined from distribution characteristics of the tracks.

### CROSS-REFERENCE TO RELATED APPLICATION(S)

This application claims priority from Korean Patent Application No. 10-2024-0152197, filed on Oct. 31, 2024, in the Korean Intellectual Property Office, the disclosure of which is incorporated herein by reference in its entirety.

### BACKGROUND

### 1. Field

The proposed invention discloses an intelligent vehicle recognition technology, and more particularly, an intelligent vehicle recognition technology applied to an intelligent transportation system.

### 2. Description of Related Art

In order to implement a fast, safe, and comfortable next-generation transportation system in accordance with an increasingly accelerating information society, an intelligent transportation system (ITS) is applied to analyze a traffic situation in real time using a computer, and based on this, road traffic management and an optimal signal system are implemented, and automation of tasks such as measuring moving time, ascertaining traffic accidents, and overweight vehicle enforcement are implemented.

In a radar scheme for performing speed control using a radar technology among technologies for controlling a speed of a vehicle, radio waves are emitted, a signal reflected back from the vehicle is analyzed, and the speed of the vehicle is measured. Specifically, the speed of the vehicle is calculated through phase change in radar waves using a Doppler effect. The radar scheme takes a short time to acquire speed information and achieves accurate speed measurement, and therefore is widely used.

However, since a conventional radar scheme does not determine a type of vehicle that is a speed measurement target, there is difficulty in imposing differential fines according to a vehicle type. Further, for speed control, it is necessary to know where a license plate is located in a point cloud shape displayed by the radar. Therefore, it is necessary to determine whether a vehicle whose speed is being measured is a large vehicle, a small vehicle, or a two-wheeled vehicle, and accordingly, the development of a speed control camera radar technology for determining a type of vehicle (type vehicle) is urgently needed.

Korean Laid-open Patent Publication No. 10-2022-0153836 (“AI-based traffic safety signal and traffic information collection system”) discloses an AI-based traffic safety signal and traffic information collection system that recognizes pedestrians and moving vehicles by receiving a moving vehicle recognition signal of a Doppler radar and driving speed detection information to enable safe driving and walking, but does not disclose a technology for determining a type of moving vehicle.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The proposed invention relates to determining a type of moving vehicle or finding a position of a license plate.

Further, the proposed invention relates to determining a type of large vehicle when a moving vehicle is a large vehicle.

According to an aspect of the proposed invention, a plurality of tracks of a vehicle driving on a road are created based on a point cloud created by 4D radar signal processing, a distribution of the tracks is analyzed, and a type of moving vehicle is determined from distribution characteristics of the tracks.

According to an additional aspect of the proposed invention, distribution information of accumulated tracks in a recognition section is processed using machine learning and a type of large moving vehicle is determined.

### BRIEF DESCRIPTION OF THE DRAWINGS

FIG. 1 illustrates an intelligent vehicle recognition device that transmits and receives a radar signal to and from a vehicle moving in a lane direction according to an embodiment.

FIG. 2 illustrates a plurality of tracks created and detected in a vehicle recognition section by the intelligent vehicle recognition device according to the embodiment.

FIG. 3 is a block diagram illustrating a configuration of the intelligent vehicle recognition device according to the embodiment.

FIG. 4 illustrates an arrangement of transmitting antennas and receiving antennas according to an embodiment.

FIG. 5 is a flowchart showing an intelligent vehicle recognition method according to an embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The above-described and additional aspects are embodied through embodiments that will be described with reference to the accompanying drawings. It will be understood that various combinations of components of each embodiment are possible within the embodiment as long as there are no other statements or contradiction. Based on the principle that the inventor can appropriately define the concepts of terms in order to explain his or her own invention in the best way, the terms used in the present specification and claims should be construed as having meanings and concepts that are consistent with the described content or the proposed technical spirit.

Blocks represented as “circuits” herein may be configured as hardware such as a dedicated semiconductor, a gate array, or a field-programmable gate array (FPGA), or a part thereof. One or more blocks may be implemented as a single piece of hardware. As another example, these blocks may be implemented as software using an information processing device in which program instructions stored in a memory element are executed by a computational element. A plurality of blocks may be implemented as part of a program executed on the same computational element. As another example, these blocks may be implemented in a hybrid form in which some individual circuits are hardware and some are software. Further, in a software implementation, computational elements may include digital signal processors, computation-dedicated processors, artificial intelligence processing engines, artificial intelligence-dedicated processors, and graphics processors, or may be any combinations thereof.

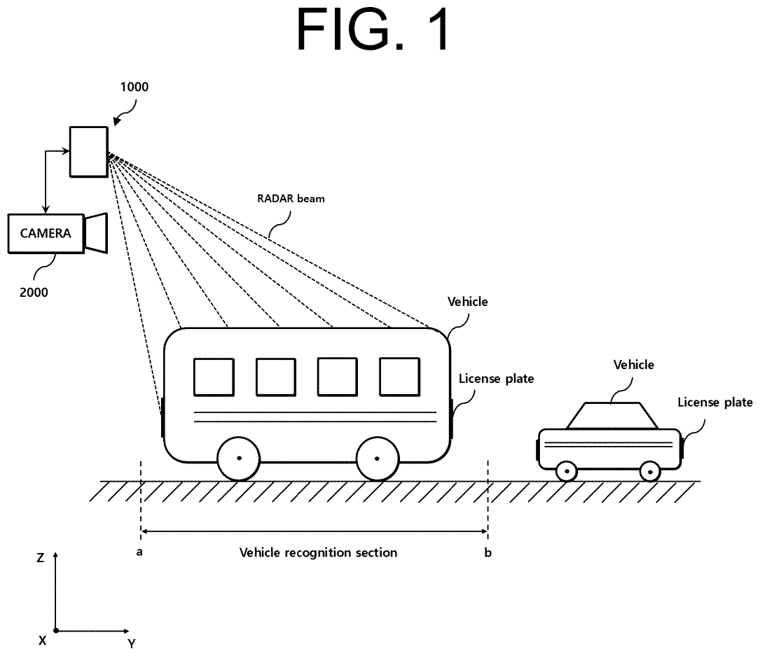

Hereinafter, preferred embodiments of the present invention will be described in detail with reference to the accompanying drawings. FIG. 1 illustrates an intelligent vehicle recognition device that transmits and receives a radar signal to and from a vehicle moving in a lane according to an embodiment. As illustrated, an intelligent vehicle recognition device 1000 may radiate a radar beam toward a vehicle driving on a road to transmit a radar signal, and receive a radar signal reflected from the vehicle. A type of the vehicle may vary depending on its shape. For example, the vehicle may be classified as a large vehicle, a small vehicle such as a passenger car, or a two-wheeled vehicle such as a motorcycle, and the large vehicle may be reclassified as a bus, a truck, or the like. The radar beam may be radiated toward a designated range, which may be defined as a vehicle recognition section indicating a distance from point a to point b in a direction of the lane. The intelligent vehicle recognition device 1000 is electrically connected to a camera 2000, which may recognize a vehicle number recorded on a license plate by referring to a position of the license plate ascertained by the radar. The intelligent vehicle recognition device 1000 and the camera 2000 may be fixedly installed on the vehicle by a support. According to another embodiment, the intelligent vehicle recognition device 1000 and the camera 2000 may also be fixedly installed on a “vehicle” by a support. The intelligent vehicle recognition device 1000 and the camera 2000 may be fixedly installed at a height of about 7 to 8 m above the ground by the support.

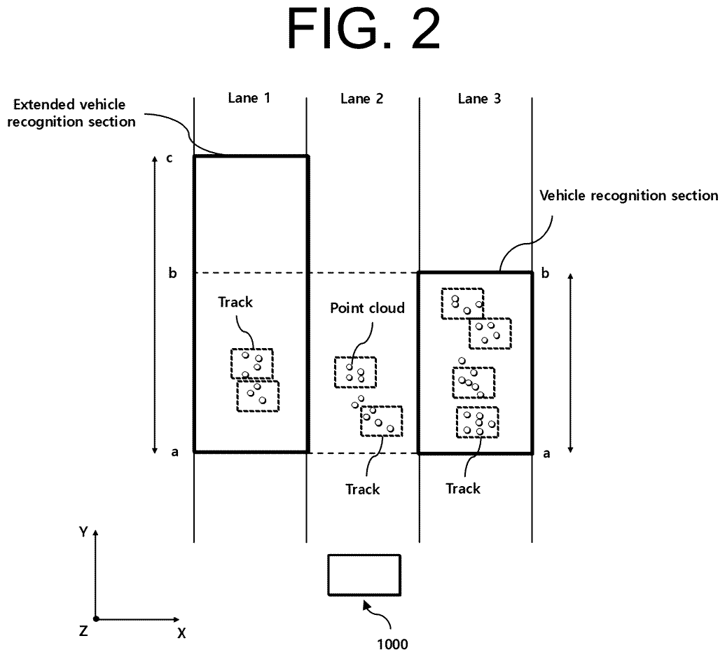

FIG. 2 illustrates a plurality of tracks created and detected in a vehicle recognition section by the intelligent vehicle recognition device according to an embodiment. As illustrated, one or more tracks including shape information of the vehicle may be created and detected in the vehicle recognition section indicating the distance from point a to point b in a lane direction (Y-axis direction). FIG. 2 illustrates that a distribution of tracks is different among lanes Lane 1, Lane 2, Lane 3 in the case of large or small vehicles.

When the vehicle is larger, the distribution of tracks is wider and longer, and an exterior structure of the vehicle is more complex, more tracks may be created. Based on this fact, an intelligent vehicle recognition device that determines a type of vehicle may be designed.

The tracks are created by clustering nearby point clouds as clusters, and one or more tracks may be created in one vehicle. In other words, the track may be a unit of a set of point clouds.

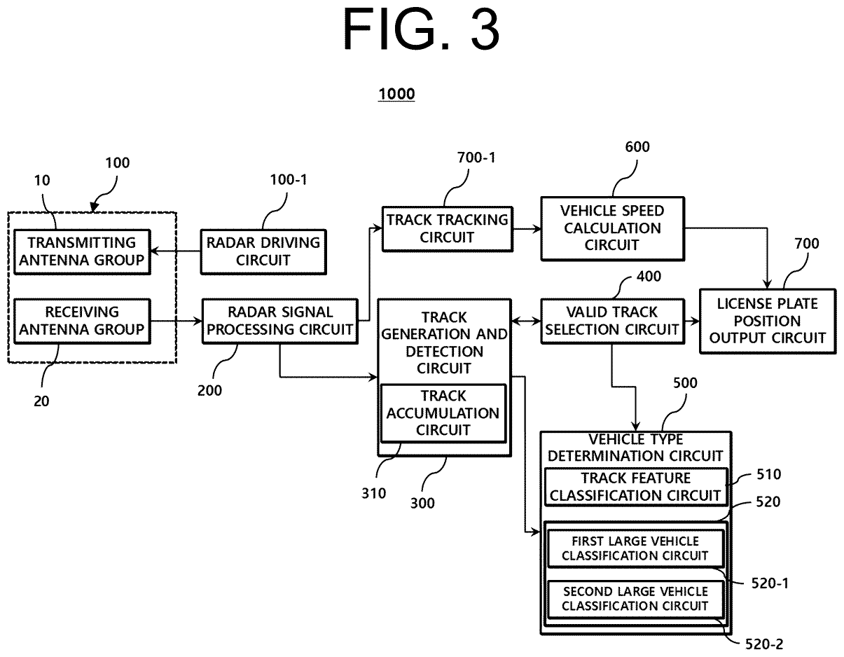

FIG. 3 is a block diagram illustrating a configuration of the intelligent vehicle recognition device according to the embodiment. As illustrated, the intelligent vehicle recognition device 1000 includes an antenna assembly 100, a radar signal processing circuit 200, a track generation and detection circuit 300, and a vehicle type determination circuit 500.

The antenna assembly 100 includes a transmitting antenna group 10 including a plurality of transmitting antennas Tx that transmit a radar signal toward a vehicle moving in a lane direction, and a receiving antenna group 20 including a plurality of receiving antennas Rx that receive a radar signal reflected from the vehicle. The transmitting antenna group 10 may be electrically connected to a radar driving circuit 100-1, and the radar driving circuit 100-1 may generate a radar transmission signal and transmit the radar transmission signal to the transmitting antenna group 10.

A plurality of transmitting and receiving antennas may be arranged in a horizontal direction and a vertical direction as multiple-input and multiple-output (MIMO) antennas so that a virtual antenna has a resolution allowing distinguishment between heights in a vertical direction as well as a horizontal resolution.

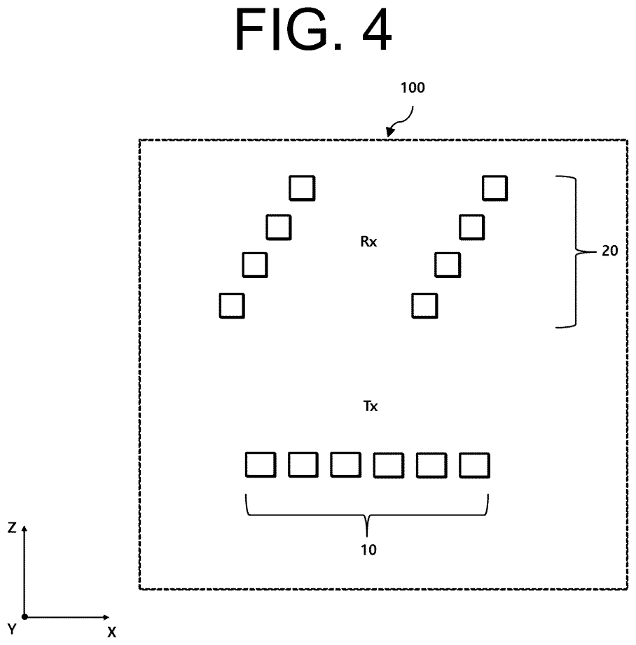

FIG. 4 illustrates an array of the transmitting antennas and the receiving antennas according to an embodiment. As illustrated, in the antenna assembly 100, the plurality of transmitting antennas or the plurality of receiving antennas are spaced apart from each other in a horizontal direction and a vertical direction. Accordingly, the track(s) of the vehicle may be created and detected in a horizontal direction (XY plane) and a vertical direction (Z axis), which may be advantageous in determining the type of vehicle. In the antenna assembly 100, the plurality of transmitting antennas or the plurality of receiving antennas may be spaced apart from each other in the horizontal direction and the vertical direction to receive a radar signal including angle of arrival (AoA) information in an azimuth direction and an elevation direction. In FIG. 4, as an example, a MIMO radar antenna assembly including six (3+3) transmitting antennas Tx and eight (4+4) receiving antennas Rx is illustrated.

Referring back to FIG. 3, the radar signal processing circuit 200 may process radar signals received by the receiving antenna group to output a radar point cloud including speed information and position information for respective points. In order to output a rich point cloud, a high-performance HW block for signal processing is used, and 20 frames or more per second may be output.

The track generation and detection circuit 300 may cluster a group of radar point clouds with similar characteristics in a direction of a vehicle lane in a designated vehicle recognition section, to create and detect a plurality of tracks representing at least a part of the vehicle.

That is, the track may be created by clustering point clouds as clusters to represent a part of the vehicle. While a large vehicle or a small vehicle moves in the direction of the lane (Y-axis direction), a plurality of tracks may be created continuously in the direction of the lane in proportion to a length of the vehicle.

The vehicle type determination circuit 500 may determine a type of vehicle by recognizing a rough outline of the vehicle based on horizontal and vertical distributions of the plurality of tracks.

When the number of consecutive tracks in the vehicle recognition section is large, the vehicle may be determined to be a large vehicle, and when the number of tracks is small, the vehicle may be determined to be a small vehicle. A width and height of the track in the vehicle recognition section may be used to distinguish between a large vehicle, a small vehicle, and a two-wheeled vehicle. When a width and height of the vehicle are determined, a leftmost point and a rightmost point among points in the several tracks in the vehicle recognition section may be found, a difference between the leftmost point and the rightmost point may be determined to be the width of the vehicle, and a largest height in the tracks may be selected as the height of the vehicle. Since several tracks represent one vehicle, a highest height, a highest width, an average of these values, and a standard deviation in the tracks may also be calculated. When clustering is performed, positions on an XY plane form one cluster and speed and height information fall within a similar range, the information is treated as a single track, so that a large vehicle and a small vehicle may be distinguished as different vehicle types even when the large vehicle and the small vehicle are located close to each other in the same lane.

According to an embodiment, track(s) may be acquired by clustering point clouds in which two or more frames are accumulated. Using height information and width information of the acquired track, a large vehicle, a small vehicle, and a two-wheeled vehicle may be primarily distinguished.

According to an embodiment, the track creation and detection circuit 300 may include a track accumulation circuit 310. The track accumulation circuit 310 may accumulate tracks included in a plurality of frames. The frame may be a minimum unit image of a continuous image representing a moving vehicle.

In general, since the point clouds of the radar have irregular blinking and motion even for consecutive frames, two or more consecutive frames may be accumulated in the vehicle recognition section in order to appropriately represent the shape of the vehicle using the point clouds. For example, all point clouds included in a distance corresponding to the vehicle recognition section during two or more frames may be collected and accumulated in one buffer, and then the type of vehicle may be determined using the accumulated point clouds.

Further, in the track accumulation, the tracks created in the respective frames may be collected and accumulated for two or more frames.

According to an embodiment, the vehicle type determination circuit 500 may include a track feature classification circuit 510. The track feature classification circuit 510 may determine a type of vehicle based on at least one of a width and height of each track belonging to the vehicle, a distance between center points of consecutive tracks, and the number of tracks. The track feature classification circuit 510 may classify a type of vehicle based on a rule with a distribution of the tracks as a feature.

According to an embodiment, the vehicle type determination circuit 500 may include a large vehicle classification circuit 520. The large vehicle classification circuit 520 may further include at least one of a first large vehicle classification circuit 520-1 and a second large vehicle classification circuit 520-2.

The first large vehicle classification circuit 520-1 may classify a 2D image acquired by projecting a spatial distribution of accumulated tracks of the recognized vehicle in three directions including forward, up, and to the side, using a machine learning algorithm, to determine a type of large vehicle when the determined vehicle is a large vehicle.

The second large vehicle classification circuit 520-2 may determine a type of large vehicle based on machine learning, with at least one of a width and height of each track belonging to the vehicle, a distance between center points of consecutive tracks, and the number of tracks as a feature, based on horizontal and vertical distributions of the tracks created and detected in an extended recognition section, when the determined vehicle is a large vehicle.

For example, a distribution of tracks including ghost tracks created in the extended vehicle recognition section due to the large vehicle within the extended vehicle recognition section of about 20 m may be set as input data in order to distinguish between types of large vehicles, and the large vehicle is specifically distinguished as a truck or a bus using a machine learning scheme such as a convolutional neural network (CNN).

When images are classified by using the machine learning algorithm to determine a type of (large) vehicle, noise tracks and/or ghost tracks included in the tracks may also be utilized.

In the case of the large vehicle, tracks created within a shape of the large vehicle include ghost tracks or noise tracks. In order to distinguish between types of large vehicles, the ghost tracks and/or noise tracks may also be included as a feature.

There may be two methods of using the machine learning algorithm. That is, there may be a deep learning scheme for distinguishing between types of (large) vehicles through the CNN or the like by using spatial distribution information of accumulated tracks in the vehicle recognition section as a two-dimensional image input, and a general machine learning scheme for extracting accumulated distribution information of the tracks in the vehicle recognition section as features to distinguish or classify types of vehicles through a support vector machine (SVM), a neural network (NN), or the like.

The large vehicle classification circuit 520 may classify a type of large vehicle based on machine learning or deep learning with the distribution of tracks as a feature.

According to an embodiment, the intelligent vehicle recognition device 1000 may include a valid track selection circuit 400. The valid track selection circuit 400 may remove ghost tracks, noise tracks, tracks including no license plate, and the like from among the plurality of tracks, and select a track including the license plate as a valid track.

In addition to the valid track, the tracks may further include ghost tracks, noise tracks, and invalid tracks, and among these, the valid track may be selected to determine the type of vehicle.

When a vehicle is scanned with radar, ghost tracks and noise tracks may be created. The noise tracks may disappear quickly as frames progress over time, but the ghost tracks may not. Shapes of ghosts are different between vehicles, and in particular, a large vehicle has various long ghosts, which may be used as a feature to classify the types of vehicles. The vehicle recognition section may be set to be longer than an actual vehicle length (for example, 20 m) in a direction in which the ghosts are generated, and may be defined as an extended vehicle recognition section. In Lane 1 illustrated in FIG. 2, an “extended vehicle recognition section” that extends from point a to point c in a lane direction (Y-axis direction) is shown.

According to an embodiment, the intelligent vehicle recognition device 1000 may further include a vehicle speed calculation circuit 600. The vehicle speed calculation circuit 600 may calculate a speed of the vehicle from positions of the same tracks present in the consecutive frames and Doppler values of the tracks.

The speed of the vehicle may be calculated using a Doppler value of the track, but may also be calculated by accumulating several frames and comparing speeds (ds/dt) of the tracks between the frames.

According to an embodiment, the intelligent vehicle recognition device 1000 may further include a license plate position output circuit 700. The license plate position output circuit 700 may output a position and speed of the license plate and the type of vehicle from valid track information determined by a valid track determination circuit when the vehicle speed calculated by the vehicle speed calculation circuit exceeds a reference speed. The intelligent vehicle recognition device 1000 may further include a speed control function. According to an embodiment, the camera 2000 may recognize a number recorded on the license plate. The intelligent vehicle recognition device 1000 may output data that enables different charging based on a type of speeding vehicle.

The intelligent vehicle recognition device 1000 is electrically connected to the camera 2000 so that the camera 2000 can recognize a vehicle number recorded on the license plate. The camera 2000 linked to the intelligent vehicle recognition device 1000 may detect the license plate using a picture taken at a position indicated by the radar. This allows the recognition of a vehicle number of a speeding vehicle.

According to an embodiment, a position of the valid track including the license plate or closest to the license plate among the tracks included in the detected outline of the vehicle may be determined as the position of the license plate.

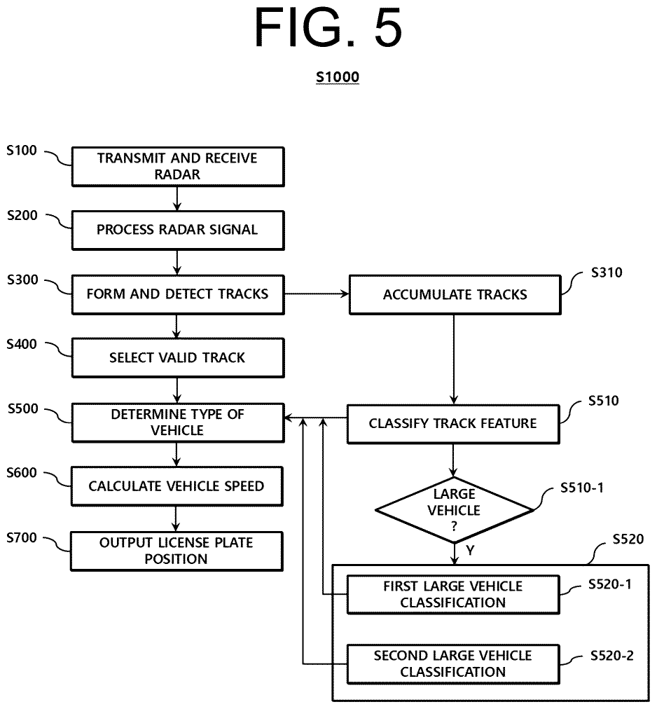

FIG. 5 is a flowchart showing an intelligent vehicle recognition method according to an embodiment. As illustrated, an intelligent vehicle recognition method S1000 according to an embodiment includes a radar transmission and reception operation S100, a radar signal processing operation S200, a track creation and detection operation S300, and a vehicle type determination operation S500, and may further include at least one of a valid track selection operation S400, a vehicle speed calculation operation S600, and a license plate position output operation S700.

In the radar transmission and reception operation S100, a transmitting antenna group including a plurality of transmitting antennas may transmit a radar signal toward a vehicle moving in a lane direction, and a receiving antenna group including a plurality of receiving antennas may receive a radar signal reflected from the vehicle;

In the radar signal processing operation S200, the radar signal received by the receiving antenna group may be processed to output a radar point cloud including speed information and position information of respective points;

In the track creation and detection operation S300, a group of dense radar point clouds having similar features in a vehicle lane direction in a designated vehicle recognition section may be clustered (collected) to create and detect a plurality of tracks representing at least a part of the vehicle.

In the vehicle type determination operation S500, a rough outline of the vehicle may be recognized based on horizontal and vertical distributions of the plurality of tracks to determine the type of vehicle.

The track may be created by clustering point clouds as clusters to represent a part of the vehicle. While a large vehicle and a small vehicle move in the direction of the lane, a plurality of tracks may be created continuously in the direction of the lane in proportion to a length of the vehicle.

When the number of consecutive tracks in the vehicle recognition section is large, the vehicle may be determined to be a large vehicle, and when the number of tracks is small, the vehicle may be determined to be a small vehicle. A width and height of the track in the vehicle recognition section may be used to distinguish between a large vehicle, a small vehicle, and a two-wheeled vehicle. When a width and height of the vehicle are determined, a leftmost point and a rightmost point among points in the consecutive tracks may be found, a difference between the leftmost point and the rightmost point may be determined to be the width of the vehicle, and a largest height in the tracks may be selected as the height of the vehicle. Since several tracks represent one vehicle, a highest height, a highest width, an average of these values, and a standard deviation in the tracks may also be calculated. When clustering is performed, positions on an XY plane form one cluster and speed and height information fall within a similar range, the information is treated as a single track, so that a large vehicle and a small vehicle may be distinguished as different vehicle types even when the large vehicle and the small vehicle are located close to each other in the same lane.

According to an embodiment, track(s) may be acquired by clustering point clouds in which two or more frames are accumulated. Using height information and width information of the acquired track, a large vehicle, a small vehicle, and a two-wheeled vehicle may be primarily distinguished.

According to an embodiment, in the radar transmission and reception operation S100, in the plurality of transmitting antennas or the plurality of receiving antennas spaced apart from each other in a horizontal direction and a vertical direction, a signal allowing measurement of the angle of arrival in the azimuth direction and the elevation direction may be received from the receiving antennas. That is, in the radar transmission and reception operation S100, MIMO antennas may be arranged so that a virtual antenna has a resolution allowing distinguishment between heights in a vertical direction as well as a horizontal resolution, and the antennas may transmit a radar signal and receive a signal allowing measurement of the angle of arrival in the azimuth direction and the elevation direction.

According to an embodiment, the track creation and detection operation S300 may include a track accumulation operation S310. In the track creation and detection operation S300, tracks included in a plurality of frames may be accumulated.

In general, since the point clouds of the radar have irregular blinking and motion even for consecutive frames, two or more consecutive frames may be accumulated in the vehicle recognition section in order to appropriately represent the shape of the vehicle using the point clouds. For example, all point clouds included in the distance corresponding to the vehicle recognition section during two or more frames may be collected and accumulated in one buffer, and then the type of vehicle may be determined using the accumulated point clouds. Further, in the track accumulation, the tracks created in the respective frames may be collected and accumulated for two or more frames.

According to an embodiment, the vehicle type determination operation S500 may include a track feature classification operation S510. In the track feature classification operation S510, a type of vehicle may be determined based on at least one of a width and height of each track belonging to the vehicle, a distance between center points of consecutive tracks, and the number of tracks.

According to an embodiment, the vehicle type determination operation S500 may include a large vehicle classification operation S520. The large vehicle classification operation S520 may further include at least one of a first large vehicle classification operation S520-1 and a second large vehicle classification operation S520-2.

In the first large vehicle classification operation S520-1, when the determined vehicle is the large vehicle, a 2D image acquired by projecting a spatial distribution of accumulated tracks of the recognized vehicle in three directions including forward, up, and to the side may be classified using a machine learning algorithm and a type of large vehicle may be determined.

In the second large vehicle classification operation S520-2, a type of large vehicle may be determined based on machine learning, with at least one of a width and height of each track belonging to the vehicle, a distance between center points of consecutive tracks, and the number of tracks as a feature, based on horizontal and vertical distributions of the tracks created and detected in an extended recognition section, when the determined vehicle is the large vehicle.

For example, a distribution of tracks including ghost tracks created in the extended vehicle recognition section due to the large vehicle within the extended vehicle recognition section of about 20 m may be set as input data in order to distinguish between types of large vehicles, and the large vehicle is specifically distinguished as a truck or a bus using a machine learning scheme such as a convolutional neural network (CNN).

When images are classified by using the machine learning algorithm to determine a type of (large) vehicle, noise tracks and/or ghost tracks included in the tracks may also be utilized.

In the case of the large vehicle, tracks created within a shape of the large vehicle include ghost tracks or noise tracks. In order to distinguish between types of large vehicles, the ghost tracks and/or noise tracks may also be included as a feature.

There may be two methods of using the machine learning algorithm. That is, there may be a deep learning scheme for distinguishing between types of (large) vehicles through the CNN or the like using spatial distribution information of accumulated tracks in the vehicle recognition section as a two-dimensional image input, and a general machine learning scheme for extracting accumulated distribution information of the tracks in the vehicle recognition section as features to distinguish or classify types of vehicles through an SVM, an NN, or the like.

According to an embodiment, the intelligent vehicle recognition method S1000 may further include a valid track selection operation S400. In the valid track selection operation S400, at least one of a ghost track, a noise track, and a track including no license plate among a plurality of tracks may be removed, and a track including a license plate may be selected as a valid track. Among the plurality of tracks, tracks relatively close to the antenna assembly may be selected as valid tracks.

When a vehicle is scanned with radar, ghost tracks and noise tracks may be created. The noise tracks may disappear quickly as frames progress over time, but the ghost tracks may not. Shapes of ghosts are different between vehicles, and in particular, a large vehicle has various long ghosts, which may be used as a feature to classify the types of vehicles. The vehicle recognition section may be set to be longer than an actual vehicle length (for example, 20 m) in a direction in which the ghosts are generated, and may be defined as an extended vehicle recognition section.

According to an embodiment, the intelligent vehicle recognition method S1000 may further include a vehicle speed calculation operation S600. In the vehicle speed calculation operation S600, the speed of the vehicle may be calculated from positions of the same tracks present in consecutive frames.

The speed of the vehicle may be calculated using a Doppler value of the track, but may also be calculated by accumulating several frames and comparing speeds (ds/dt) of the tracks between the frames.

According to an embodiment, the intelligent vehicle recognition method S1000 may further include a license plate position output operation S700. In the license plate position output operation S700, when the vehicle speed calculated by the vehicle speed calculation circuit exceeds the reference speed, a position and speed of the license plate and the type of vehicle may be output from valid track information determined by a valid track determination circuit.

According to an embodiment, the camera may recognize a number recorded on the license plate. The intelligent vehicle recognition device may output data that enables different charging based on a type of speeding vehicle.

The description of FIGS. 1 to 4 may be combined with reference to FIG. 5.

According to the proposed invention, it is possible to three-dimensionally ascertain a track distribution of the vehicle and scan a wide area to accurately determine a type of moving vehicle and to ascertain a position of a license plate. Further, it is possible to determine a type of large vehicle that is traveling.

The effects of the present invention are not limited to the effects described above, and effects that are not mentioned may be clearly understood by those skilled in the art from the present specification and the accompanying drawings.

Although the present invention has been described above through embodiments with reference to the accompanying drawings, the present invention is not limited thereto and should be construed to encompass various modified examples that may be obviously derived from the embodiments by those skilled in the art. The claims are intended to encompass such modified examples.

What is claimed is:

1. An intelligent vehicle recognition device applied to an intelligent transportation system, comprising:
an antenna assembly including a transmitting antenna group including a plurality of transmitting antennas configured to transmit a radar signal toward a vehicle moving in a lane direction, and a receiving antenna group including a plurality of receiving antennas configured to receive a radar signal reflected from the vehicle;
a radar signal processing circuit configured to process the radar signal received by the receiving antenna group to output a radar point cloud including speed information and position information of each point;
a track generation and detection circuit configured to cluster a group of dense radar point clouds having similar features in a vehicle lane direction in a designated vehicle recognition section to create and detect a plurality of tracks representing at least a part of the vehicle; and
a vehicle type determination circuit configured to recognize a rough outline of the vehicle based on horizontal and vertical distributions of the plurality of tracks to determine a type of vehicle.

2. The intelligent vehicle recognition device of claim 1, wherein, in the antenna assembly, the plurality of transmitting antennas or the plurality of receiving antennas are spaced apart from each other in a horizontal direction and a vertical direction to receive a radar signal including angle-of-arrival information in an azimuth direction and an elevation direction.

3. The intelligent vehicle recognition device of claim 1, wherein the track creation and detection circuit includes a track accumulation circuit configured to accumulate tracks included in a plurality of frames.

4. The intelligent vehicle recognition device of claim 1, wherein the vehicle type determination circuit includes a track feature classification circuit configured to determine a type of vehicle based on at least one of a width and height of each track belonging to the vehicle, a distance between center points of consecutive tracks, and the number of tracks.

5. The intelligent vehicle recognition device of claim 1, wherein the vehicle type determination circuit further includes
a first large vehicle classification circuit configured to classify a 2D image acquired by projecting a spatial distribution of accumulated tracks of the recognized vehicle in three directions including forward, up, and to the side, using a machine learning algorithm, to determine a type of large vehicle when the determined vehicle is a large vehicle; and
a second large vehicle classification circuit configured to determine a type of large vehicle based on machine learning, with at least one of a width and height of each track belonging to the vehicle, a distance between center points of consecutive tracks, and the number of tracks as a feature, based on the horizontal and vertical distributions of the tracks created and detected in an extended recognition section when the determined vehicle is a large vehicle.

6. The intelligent vehicle recognition device of claim 1, further comprising a valid track selection circuit configured to remove at least one of a ghost track, a noise track, and a track including no license plate from among the plurality of tracks, and select a track including a license plate as a valid track.

7. The intelligent vehicle recognition device of claim 3, further comprising:
a vehicle speed calculation circuit configured to calculate a speed of the vehicle from positions of the same tracks present in the consecutive frames and Doppler values of the tracks.

8. The intelligent vehicle recognition device of claim 7, further comprising:
a license plate position output circuit configured to output a position and speed of a license plate and a type of vehicle from track-of-interest information determined by a track-of-interest determination circuit when the speed of the vehicle calculated by the vehicle speed calculation circuit exceeds a reference speed.

9. An intelligent vehicle recognition method (S1000) applied to an intelligent transportation system, the method comprising:
a radar transmission and reception operation (S100) of transmitting, by a transmitting antenna group including a plurality of transmitting antennas, a radar signal toward a vehicle moving in a lane direction, and receiving, by a receiving antenna group including a plurality of receiving antennas, a radar signal reflected from the vehicle;
a radar signal processing operation (S200) of processing the radar signal received by the receiving antenna group to output a radar point cloud including speed information and position information of respective points;
a track creation and detection operation (S300) of clustering a group of dense radar point clouds having similar features in a vehicle lane direction in a designated vehicle recognition section to create and detect a plurality of tracks representing at least a part of the vehicle; and
a vehicle type determination operation (S500) of recognizing a rough outline of the vehicle based on horizontal and vertical distributions of the plurality of tracks to determine a type of vehicle.

10. The intelligent vehicle recognition method (S1000) of claim 9, wherein the radar transmission and reception operation (S100) includes receiving a signal allowing measurement of an angle of arrival in an azimuth direction and an elevation direction from the receiving antennas in the plurality of transmitting antennas or the plurality of receiving antennas spaced apart from each other in a horizontal direction and a vertical direction.

11. The intelligent vehicle recognition method (S1000) of claim 9, wherein the track creation and detection operation (S300) includes a track accumulation operation (S310) of accumulating tracks included in a plurality of frames.

12. The intelligent vehicle recognition method (S1000) of claim 9, wherein the vehicle type determination operation (S500) includes a track feature classification operation (S510) of determining a type of vehicle based on at least one of a width and height of each track belonging to the vehicle, a distance between center points of consecutive tracks, and the number of tracks.

13. The intelligent vehicle recognition method (S1000) of claim 9, wherein the vehicle type determination operation (S500) includes
a first large vehicle classification operation (S520-1) of classifying a 2D image acquired by projecting a spatial distribution of accumulated tracks of the recognized vehicle in three directions including forward, up, and to the side, using a machine learning algorithm, to determine a type of large vehicle when the determined vehicle is the large vehicle; and
a second large vehicle classification operation (S520-2) of determining a type of large vehicle based on machine learning, with at least one of a width and height of each track belonging to the vehicle, a distance between center points of consecutive tracks, and the number of tracks as a feature, based on the horizontal and vertical distributions of the tracks created and detected in an extended recognition section when the determined vehicle is a large vehicle.

14. The intelligent vehicle recognition method (S1000) of claim 9, further comprising a valid track selection operation (S400) of removing at least one of a ghost track, a noise track, and a track including no license plate from among the plurality of tracks, and selecting a track including the license plate as a valid track.

15. The intelligent vehicle recognition method (S1000) of claim 11, further comprising a vehicle speed calculation operation (S600) of calculating a vehicle speed from positions of the same tracks present in consecutive frames and Doppler values of the tracks.

16. The intelligent vehicle recognition method (S1000) of claim 15, further comprising a license plate position output operation (S700) of outputting a position and speed of a license plate and the type of vehicle from valid track information determined by a valid track determination circuit when the vehicle speed calculated by a vehicle speed calculation circuit exceeds a reference speed.
